(19) United States
(12) Patent Application Publication
(10) Pub. No.: US 2022/0270346 A1
(43) Pub. Date: Aug. 25, 2022

(54) IMAGE PROCESSING USING SELF-ATTENTION

(71) Applicant: HUAWEI TECHNOLOGIES CO., LTD., Shenzhen (CN)

(72) Inventors: Francesca BABILONI, London (GB); Ioannis MARRAS, London (GB); Gregory SLABAUGH, London (GB); Stefanos ZAFEIRIOU, London (GB)

(73) Assignee: HUAWEI TECHNOLOGIES CO., LTD., Shenzhen (CN)

(21) Appl. No.: 17/742,704

(22) Filed: May 12, 2022

Related U.S. Application Data
(63) Continuation of application No. PCT/EP2019/081372, filed on Nov. 14, 2019.

(51) Int. Cl. G06V 10/42; G06V 40/16; G06V 10/77; G06V 10/82

(52) U.S. Cl. CPC G06V 10/42; G06V 40/168; G06V 10/7715; G06V 10/82

(57) ABSTRACT

An image processing device for identifying one or more characteristics of an input image, the device including a processor configured to: receive the input image, the input image extending along a first axis and a second axis; form a series of attribute maps based on the received input image; perform a first correlation operation by identifying regions in respect of which the patterns of multiple ones of the series of attribute maps are correlated, and forming a first output in dependence on that operation; perform a second correlation operation for identifying combinations of (i) attributes and (ii) portions of the image having common location in terms of the first axis, and forming a second output in dependence on that operation; and form a representation of the one or more characteristics of the input image in dependence on at least the first output and the second output.

### CROSS-REFERENCE TO RELATED APPLICATIONS

This application is a continuation of International Application No. PCT/EP2019/081372, filed on Nov. 14, 2019, the disclosure of which is hereby incorporated by reference in its entirety.

### FIELD

The embodiments relate to image processing and computer vision.

### BACKGROUND

It is known to use a deep neural network such as a convolutional neural network (CNN) for image analysis. In a CNN, an image is processed successively by multiple layers of convolution and non-linearity (such as a rectified linear unit (ReLU)) to extract features. These features are abstractions of the image data. The features can themselves be processed by further layers of convolution and non-linearity to transform the features into further levels of abstraction.

Image features including video frames can be described as tensors. A tensor can be thought of as a matrix in a number of dimensions. The dimension of the tensor is called its rank, denoted as D. A 0D tensor corresponds to a single number or scalar, a 1D tensor to a vector, 2D tensor to a matrix, a 3D tensor to a 3D array of numbers, and so on. The tensor can be thought of as an abstract representation of some data input. A tensor may be employed to represent complex data structures such as images and video in computer vision, corpora of text in natural language processing or gene expressions in bioinformatics.

For illustration, FIG. 1 shows schematically an example of a CNN designed for image classification. The output of each layer is a 3D tensor, which is then input to the next layer and so on until a final fully connected layer makes a classification using the abstracted features extracted from the image.

A desirable feature of a CNN is to extract meaningful task-specific features to solve a particular problem, for example, high level vision problems like image classification or low level vision problems like image inpainting or image-to-attribute mapping. Applications of inpainting or image-to-attribute mapping include forming an image of high perceived quality (e.g., in RGB format) from a source image as captured by a camera sensor (e.g., in RAW format) or from an image that is in some way corrupted (e.g., because a part of the image is missing). Capturing better features in the source image can have a dramatic influence on the performance of the CNN.

Images often exhibit a high degree of self-similarity. For example, an image may include multiple faces. By taking advantage of this self-similarity, even pixels of an image that are not adjacent to each other (i.e., pixels that are non-local, or long-range with respect to each other) can support each other to enrich the features extracted and encoded in a tensor describing the image.

In computer vision, several traditional image processing operations take advantage of self-similarity information. A noticeable example is the well-known image denoising technique of BM3D, which draws similarity between pairs of patches of the input image.

Nonetheless, the state-of-the-art in computer vision and image processing are convolutional neural networks, which typically outperform traditional methods in a variety of tasks (e.g., demosaicing, denoising, color enhancement). However, a disadvantage of these models in some implementations of limited computing power can be the need to process each input point only as a function of its neighboring region, without taking into account long-range dependencies in the input.

Recently, Wang et al. (Wang, X, Girshick, R, Gupta, A & He, K (2018) “Non-local neural networks” Proceedings of the IEEE Conference on Computer Vision and Pattern Recognition (pp 7794-7803) proposed a non-local block for a CNN which tries to estimate spatial correlations among positions of the input tensor.

There is a need for an improved way of performing image processing that takes account of similarity within an image.

According to one aspect there is provided an image processing device for identifying one or more characteristics of an input image, the device comprising a processor configured to: receive the input image, the input image extending along a first axis and a second axis; form a series of attribute maps based on the received input image, each attribute map representing the intensity of a respective attribute at a plurality of locations in the image; perform a first correlation operation by identifying regions in respect of which the patterns of multiple ones of the series of attribute maps are correlated, and forming a first output in dependence on that operation; perform a second correlation operation for identifying combinations of (i) attributes and (ii) portions of the image having common location in terms of the first axis, wherein the said combinations are correlated across multiple locations in terms of the second axis, and forming a second output in dependence on that operation; and form a representation of the one or more characteristics of the input image in dependence on at least the first output and the second output.

The processor may be configured to: perform a third correlation operation for identifying combinations of (i) attributes and (ii) portions of the image having common location in terms of the second axis, wherein the said combinations are correlated across multiple locations in terms of the first axis, and forming a third output in dependence on that operation; wherein forming the representation of the one or more characteristics of the input image is further in dependence on the third output. By performing self-attention on an additional dimension, further information about the one or more characteristics of the image can be derived.

The image may be a still image or a part (e.g., a frame) of a video.

One of the first axis and the second axis may be a horizontal image axis X. The other one of the first axis and second axis may be a vertical image axis Y. The attributes may form a set C and the image and the attribute maps may together form a tensor having dimensions C, X and Y. This provides a convenient way to analyze the data from the image.

The output of the first correlation operation may be a similarity matrix for dimensions X, Y; and the output of the second correlation operation may be a similarity matrix for dimensions C and one of X and Y. This provides a convenient way to analyze the image.

The attributes may include one or more of: the presence of a certain hue, brightness, local contrast, and a determined representation of the local likelihood of a certain feature. The feature may be a face.

The processor may be configured to perform a feature recognition operation on the input image to form a map comprising estimates of the local likelihood of a certain feature at a plurality of locations in the input image. That map may constitute one of the attribute maps. The device may perform feature recognition on the input image to recognise features therein, and the local presence of such a feature may be estimated in response to such a feature recognition process. This can allow for the identification of feature similarities at spaced-apart locations in the image.

The processor may be configured to train a convolutional neural network in dependence on the said representation. The trained network may then be used for image processing.

According to a second aspect there is provided a method for identifying one or more characteristics of an input image, the method comprising: receiving the input image, the input image extending along a first axis and a second axis; forming a series of attribute maps based on the received input image, each attribute map representing the intensity of a respective attribute at a plurality of locations in the image; performing a first correlation operation by identifying regions in respect of which the patterns of multiple ones of the series of attribute maps are correlated, and forming a first output in dependence on that operation; performing a second correlation operation for identifying combinations of (i) attributes and (ii) portions of the image having common location in terms of the first axis, wherein the said combinations are correlated across multiple locations in terms of the second axis, and forming a second output in dependence on that operation; forming a representation of the one or more characteristics of the input image in dependence on at least the first output and the second output; and training a convolutional neural network in dependence on the said representation.

The identified regions may be regions of the image and/or regions of a tensor describing the image. The tensor may have spatial dimensions corresponding to those of the image and a feature or attribute dimension.

The attribute maps may be or include feature maps. The attribute maps may include the input image itself.

According to a third aspect there is provided an image processing device storing a model formed by the method as set out above, the device comprising a processor configured to receive a second input image and process the second input image by the model to form an output image.

The processor may be configured to process the second input image by the model to perform on the second input image one of a repainting operation, a raw to RGB operation and a tile reordering operation. This can allow the processor to improve the quality of the input image.

The device as described above may be a self-contained device in a single housing, or may be a distributed device, e.g., involving multiple computers which may be at the same or different locations. Such a device may comprise one or more processors for performing the steps described above, and a memory for storing in a non-transient way code for execution by such processor to perform the method.

### BRIEF DESCRIPTION OF THE DRAWINGS

The system will now be described by way of example with reference to the accompanying drawings. In the drawings:

FIG. 1 is a schematic diagram of a CNN for image processing.

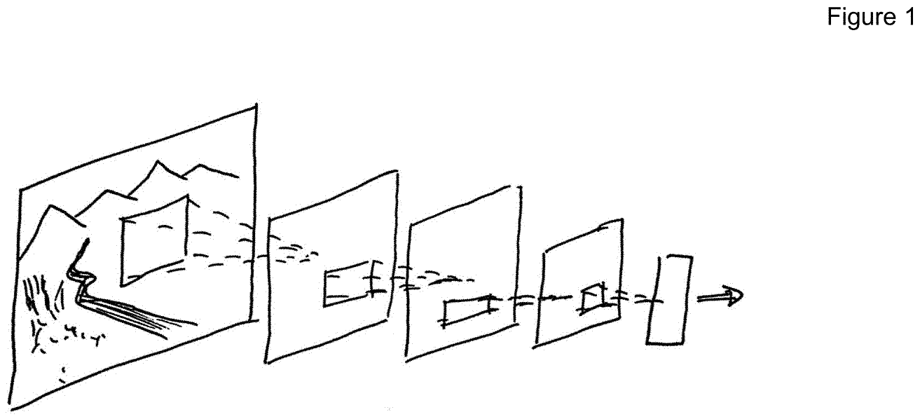

FIG. 2a illustrates the concept of performing correlations across multiple dimensions.

FIG. 2b illustrates an example of the correlations performed as illustrated in FIG. 2a.

FIG. 3 illustrates an embodiment of a tensor self-attention architecture.

FIG. 4 illustrates details of a block according to the architecture of FIG. 3.

FIG. 5 illustrates flow in an embodiment of a tensor self-attention process.

FIG. 6 shows the standard Bayer pattern color filter array on a sensor.

FIG. 7 illustrates color packing into a mosaic.

FIG. 8 illustrates a variant of Unet architecture for implementing the system described herein.

FIG. 9 shows a comparison of results for a Raw to RGB processing task.

FIG. 10 shows results for an inpainting task.

FIG. 11 shows results for an inpainting task.

### DETAILED DESCRIPTION OF THE EMBODIMENTS

The image processing system to be described herein involves extracting information about the intensity of a range of attributes at locations across an image. For each attribute, a representation (e.g., a set of data) is formed which represents the intensity of that attribute at multiple locations in the image. Those locations may be spaced regularly or irregularly. Conveniently they may correspond to the locations of pixels or blocks of pixels in the image. Each representation may be an attribute map of the intensity of the respective attribute in the image. The representations may be combined into a 3D tensor of which two axes correspond to spatial axes of the image (conveniently horizontal (X) and vertical (Y) axes of the image) and the third axis corresponds to the set of attributes (C). One of the attributes may be the data of the input image itself; or the image itself may be an X,Y matrix forming one 2D layer in C of the tensor. A value in the tensor at an X,Y,C location represents the intensity of attribute C at location X,Y in the image.

Non-limiting examples of the attributes may include the brightness, local contrast, or the presence of a certain color or feature (e.g., a face, person, vehicle, sign, or animal).

The tensor is then processed to detect similarities between 2D components in the tensor. Each 2D component (“layer”) of the tensor describes a pattern of intensity. Those patterns are compared along the third axis of the tensor to form an intermediate comparison output. Importantly, that process is performed for 2D layers that include the C axis of the tensor, the comparison of the patterns of such layers being performed along a spatial (X or Y) axis of the tensor. This enables additional information to be gathered about similarities in parts of the image, such as repeating patterns.

Put another way, in a first comparison step 2D layers in X,Y which differ from each other in C are compared to detect similarities that occur in their patterns. The comparison detects regions of those layers which have similarities at common X,Y locations. An intermediate output of this step is generated. This output may indicate X,Y regions of the image where multiple attributes are particularly intense or non-intense. In a second comparison step 2D layers in C and one of X and Y which differ from each other in the other of X and Y are compared to detect similarities that occur in their patterns. For ease of explanation, it will be supposed that those 2D layers are in C and X, but the second comparison step can be performed mutatis mutandis for 2D layers in C and Y. The comparison or correlation operation detects regions of those layers which have similarities at common C,X locations. An intermediate output of this step is generated. This output may indicate combinations of X and C for which there is a common tendency to intensity or non-intensity of attributes along Y. A third comparison step may be performed in a similar way for 2D layers in C and the other of X and Y. Then the intermediate outputs can be processed together to derive information about similarities across the input image.

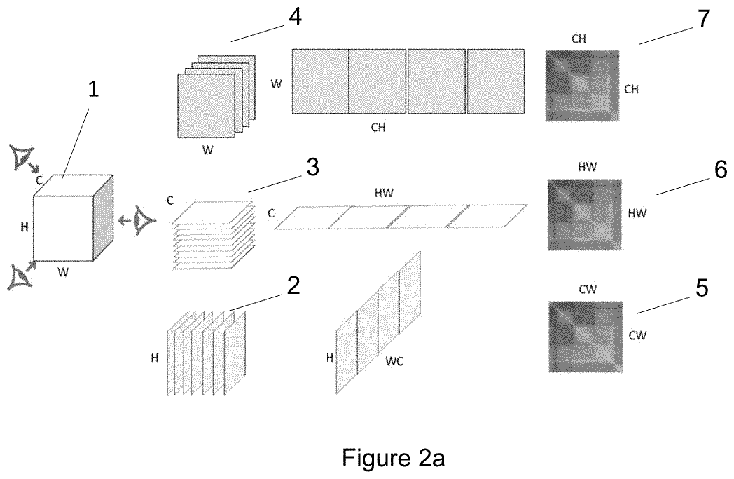

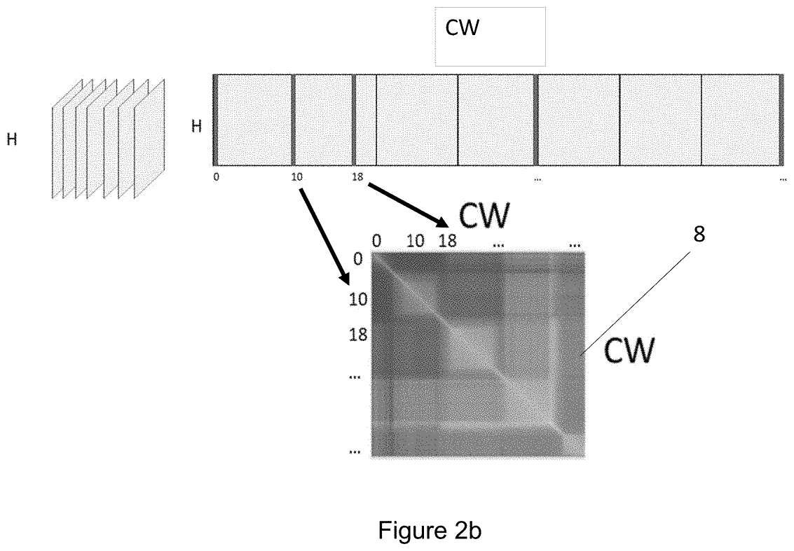

FIG. 2a illustrates this approach. An input tensor 1 having dimensions X (alternatively referred to as W), Y (alternatively referred to as H) and C is formed. The input tensor may be composed of sets of layers 2, 3, 4 in C,W, H,W and C,H respectively. The elements within each layer of each of those sets are compared to each other identify similarities in the patterns they exhibit at common locations in the plane of the respective layer. For example, the C,W layers 2 are compared with each other to identify similarities in their patterns at common location H. Each of these three comparisons results in a respective intermediate output 5, 6, 7 which represents the strength of commonality in intensity of elements within the layers at locations across the respective axis pair. For example, intermediate output 5 represents the locations in C,W where there is commonality in intensity or non-intensity. Each intermediate output comprises a set of scores indicating for a respective location in the plane of the respective axis pair the overall similarity of or deviation between values in the tensor 1. This method can describe complex relationships present in the input tensor. Each intermediate output is a similarity matrix for a respective plane of the input tensor (HWxHW, CHxCH, CWxCW). Conveniently, each point in the matrix can hold a score (e.g., from 0 to 1) expressing how close the elements in the respective rank of the input tensor orthogonal to the dimensions of the similarity matrix are to each other.

FIG. 2b illustrates the situation where the C,W layers 2 are compared with each other to identify similarities in their patterns at common locations. Each C,W element is described by a series of H attributes, which are then compared. In the figure, a comparison between the 10th and 18th CW elements is shown.

Thus, a tensor describing the patterns of multiple attributes across an image can be analyzed in multiple dimensions. This process can yield information about the image that can assist its analysis. In one example, a device may receive an input image for processing; analyze the image to detect the patterns of multiple attributes in the image, thereby forming the input tensor; analyze the input tensor as described above; and then use the output 8 of that analysis to perform a function such as improving the quality of the image or detecting features in the image. In another example, the analysis of the tensor in the manner described above may be used to train a machine learning algorithm. In this example, a device may receive multiple images in turn, and for each image analyze the image to detect the patterns of multiple attributes in the image, thereby forming the input tensor and analyze the input tensor as described above. The result of that analysis can then be input to a machine learning model. The machine learning model can then generate an adapted version of the image, which can be tested against a ground truth image (e.g., a version of the respective input image having improved quality). In dependence on that comparison the machine learning model can be adapted. After multiple iterations of this process the machine learning model can be stored and passed to other devices for use by them. In each case, the respective data processing steps can be performed by one or more computers programmed with suitable code executable by the computer(s), the code being stored in a non-transient way, e.g., in a non-volatile memory. Each computer may have one or more processors for executing the code.

To implement processes such as those described above, there may be provided a module which, given an input tensor, captures complex inter-dependencies using self-attention information extracted along different dimensions of the tensor. The extracted self-attention information is combined with the input, creating in this way an output tensor of the same dimensionality but with higher discriminative power. In one embodiment, the self-attention information can be extracted using a machine learning algorithm. In that approach, the proposed self-attention process can be performed in dependence on learned or learnable parameters.

In summary, to highly exploit relationships among elements in the input tensor, self-attention is computed on all multiple, and potentially all, dimensions of the input tensor. In contrast to prior approaches, this approach can capture correlations across channels/attributes. This tensor self-attention mechanism can be applied one or multiple times in a deep CNN to improve its performance.

A self-attention mechanism can be a mechanism that identifies interconnections or dependences in an input. A typical self-attention mechanism uses a similarity function, which is typically a real-valued function that quantifies the similarity between two signals. Although no single definition of similarity measure exists, usually such measures are implemented to behave like the inverse of a distance metrics: they take on relatively large values for similar signals and either zero or a negative value for very dissimilar signals.

As indicated above, similarity can be identified independently along each dimension of the input tensor. Working along different dimensions of the tensor allows extraction of similarity not just spatially but along across channels, potentially capturing a richer similarity information.

The input tensor may have different extents in each of its dimensions, depending on the size and aspect ratio of the input image and the number of channels analyzed. As a result, extracting similarity in multiple dimensions may result in intermediate output matrices of different sizes. It is convenient to fuse these matrices to produce an output tensor the same size as the input tensor. The resulting output tensor has features that have been enriched by self-attention. These features have higher discriminative power than those produced by some other approaches and can produce more accurate outputs.

The process of analyzing the input tensor as described herein can be used to benefit a variety of computer vision problems when used as a block in a deep neural network. Examples of such problems include inpainting (i.e., filling in areas of missing data in an image), Raw to RGB mapping and reconstruction of an image from reordered or shuffled parts of that image.

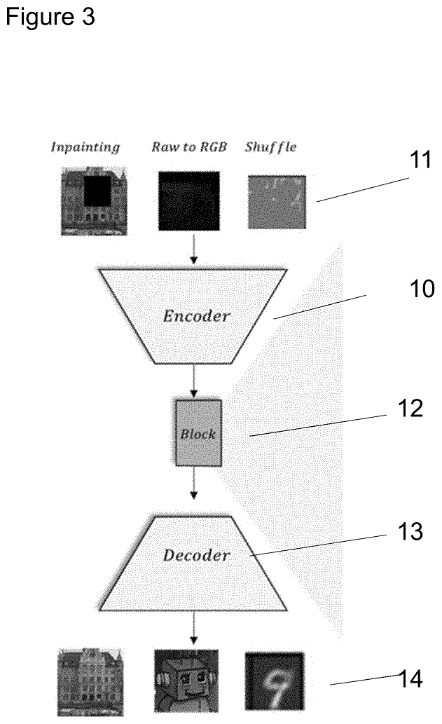

FIG. 3 depicts the high level structure of the proposed method when used as a deep learning block. The deep learning model encoder 10 maps a degraded input 11 into a tensor X. This comprises the combination of attribute maps forming the input tensor. These are processed in self-attention block 12 at the bottleneck of the CNN in the manner described above. The output of the self-attention block 12 is passed to a decoder 13 which operates on the input image in dependence on the output of block 12 to form an output image 14.

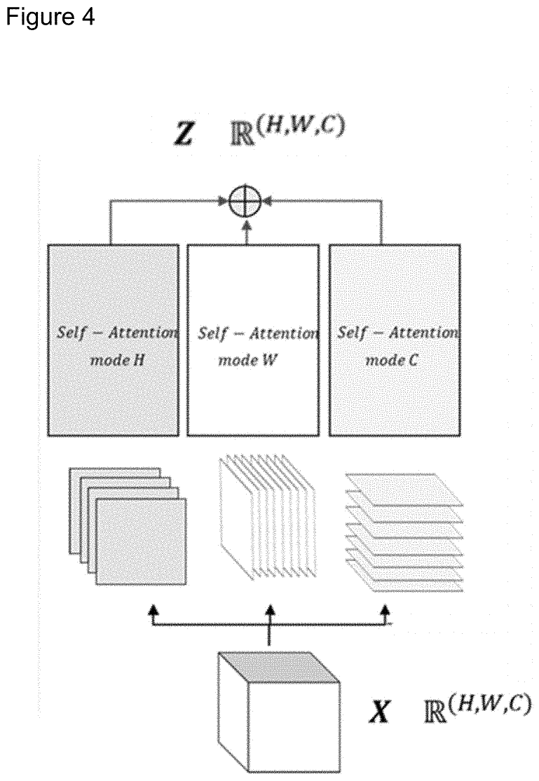

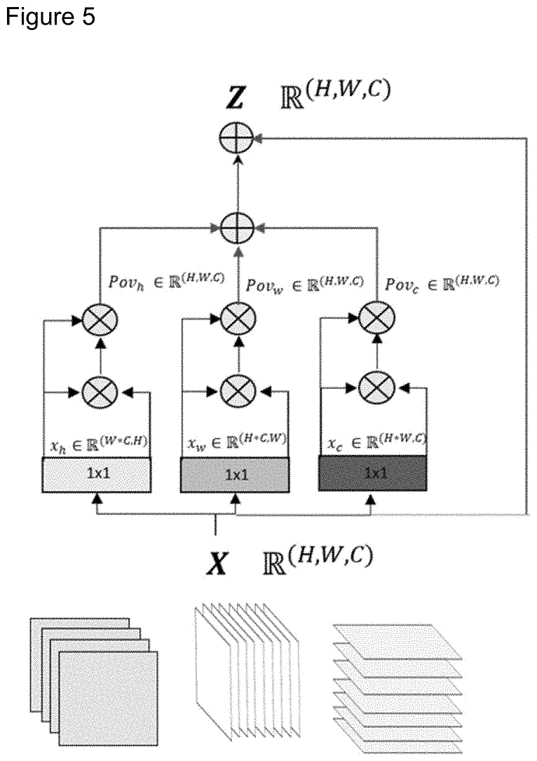

FIG. 4 shows in more detail the content of the self-attention block 12 in one embodiment. FIG. 5 shows an embodiment of tensor-self-attention. On each of its dimensions the tensor is considered as a set of matrices. To each matrix is applied one convolution with kernel 1×1, followed by a sequence of 2 matrix multiplications. This or another suitable process implements self-attention on each of those sets of matrices. The outputs of these are combined to form an output tensor Z. The method can be used in a variety of problems including inpainting, Raw to RGB, and reconstructing shuffled inputs. In the system of FIG. 5, self-attention is embodied as a matrix multiplication. Other operations could be used instead.

Given an N-order dimension tensor, the process described herein applies N parallel and independent self-attention mechanisms to extract different information from the same input. The process then fuses their contributions together with the original input tensor.

Matricization, also known as unfolding or flattening, is the process of re-ordering the elements of an N-way array into a matrix. For instance, a 2×3×4 tensor can be arranged as a 6×4 matrix or a 3×8 matrix, and so on. The mode-n matricization of a tensor is denoted by X(n) and arranges the mode-n fibers of X to be the columns of the resulting matrix.

The input tensor X is a 3D tensor representation of a 2D input image. It is extracted using a CNN module (e.g., encoder 10 of FIG. 3). The tensor self-attention block 12 takes X as input and outputs its enriched representation Z. The use of the present method can allow the subsequent decoder module 13 to achieve higher quality output images.

The input tensor X of dimensions X×Y×C is unfolded in its 3 modes. In other words, it is rearranged into 3 different sets of 2-D matrices. Each matrix set focuses on different slices of the input. Given this tensor representation, a self-attention module is applied to each of the modes separately. All the self-attention outputs are then combined with the input tensor to produce the output.

In CNNs, convolutional operations are building blocks that process one local neighborhood at a time. Thus, long-range dependencies can be captured when these operations are applied repeatedly. This comes with several limitations such as computational inefficiency and optimization difficulties. To help address this issue, the present method computes useful complex interdependencies of the input tensor.

FIG. 5 shows a self-attention module in more detail. In FIG. 5 a “+” sign represents a summation, a “X” sign represents matrix multiplication and arrows represent inputs where there may be modulation by a learnable scalar. Where indicated, the rectangles represent a 1×1 convolution operation. The module implements a self-similarity module which performs the following steps

1) Unfolds an N-order input tensor in its respective N modes and embeds each mode in a separate learned subspace using convolution operators

2) Computes for each nth embedded mode (X,Y,C) the response of every one of its elements given all the other elements using the matrix multiplication operator. Doing so, the method may process all possible pairs and computes a similarity score for each of them producing a mode-n-attention map. Another matrix multiplication with the original nth-mode input integrates this similarity information in the output features. This procedure is described by the following equation: POVₙ=(XₙXₙ^{t})Xₙ

3) Sums the output of each mode's self-attention with the original input features through a residual connection. This can enhance the discriminative power of the original input tensor.

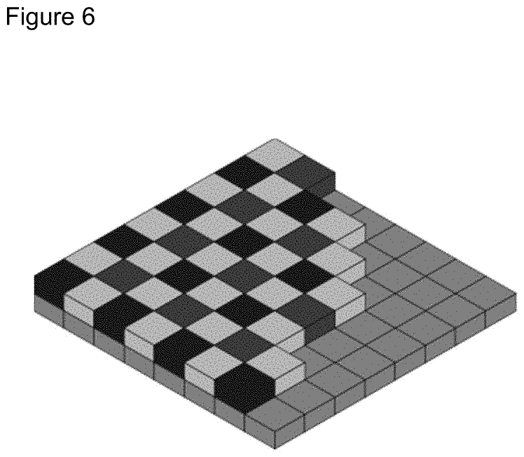

An example of how such a module can be used will now be described. In this example the module is used in a deep learning process to perform Raw to RGB encoding. This non-limiting embodiment of the present approach is based on deep learning (e.g., using a CNN). The stage has as input raw data. The raw data passed as input may be an image formed using a color filter array (CFA) that captures light of specific colors at each pixel, for example, using the well-known Bayer pattern shown in FIG. 6. This pattern has a recurring 2×2 mosaic that is tiled across the image. The 2×2 mosaic includes a blue color element, two green color elements and a red color element. Often the raw data captured has a large dynamic range: 10 bit data can represent 1024 different levels at each red, green, or blue color. An image captured in this format is said to be mosaicked.

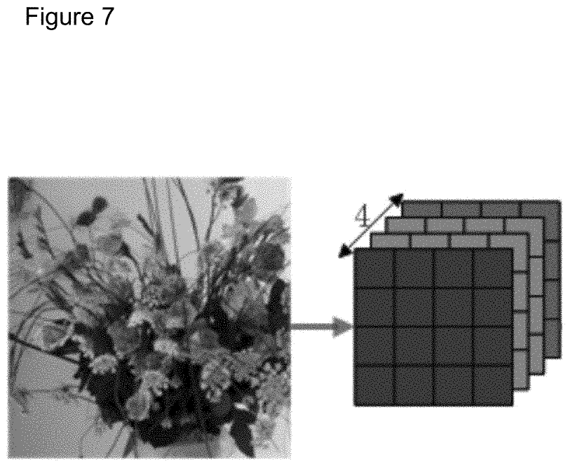

A mosaicked image can be packed into four color channels representing the red, first green second green and blue colors, as illustrated in FIG. 7. In the packed form, the spatial resolution of each color channel is half the original mosaicked image resolution.

The method applies a convolutional neural network to process the mosaicked image. A CNN learns a collection of filters, which are applied to the image through convolution The convolution is designed to be spatially invariant, meaning the convolution has the same effect when applied to any location in the image. When applying convolutions on a mosaicked image it is desirable the convolutions remain spatially invariant despite the design of the CFA (for example, when a filter is centered on a blue pixel, it could have a different effect than when centered on a red pixel). A simple way to achieve this is to pack the data into like-color channels, each of which can then be processed in the CNN using spatially invariant convolutions.

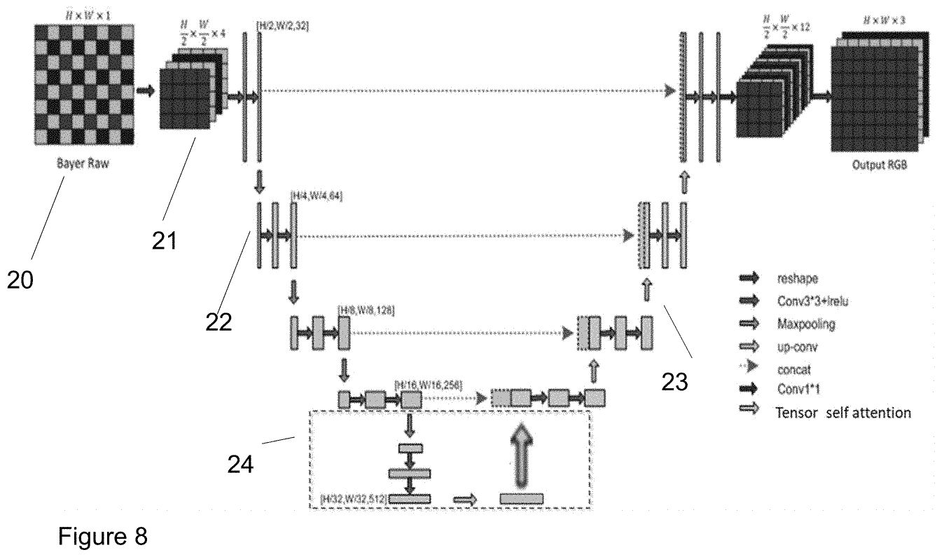

An example of a suitable CNN design is presented in FIG. 8. This network takes a raw single channel input 20, packs the data into four channels 21, which are then processed with a Unet. This fully convolutional network uses an encoder-decoder architecture with skip connections. Between the encoder 22 and the decoder 23 part of the network, a tensor self-attention block 24, e.g., of the type described above, integrates information about self-similarity.

The encoder part 22 processes the raw input with five consecutive layers. Each layer applies to its input two banks of 3×3 convolutional filters (together with a ReLU activation function) and one “max pooling” operation. The first convolution increases the number of filters (i.e., channels) by a factor of two. The max pooling operation reduces the spatial image resolution by a factor of two (i.e., from X, Y, C to X/2, Y/2, C). The image is processed at multiple scales and the network adapts to different frequency content. This produces output channels that capture features inherent in the data and relevant to the Raw to RGB task.

As mentioned above, the tensor self-attention module 24 is used to compute self-attention on the input tensor. It takes as input the encoder-features (X/32, Y/32, 512) and produce as output a matrix with the same dimensionality.

The decoder part 23 processes the output of the tensor self-attention block with four consecutive layers of two banks of 3×3 convolutional filters and a transposed convolution operation. The transposed convolution is an upsampling layer which increases the spatial resolution by a factor of two in each dimension (width and height) and decreases the number of filters by a factor of two. The input to each layer is a concatenation of (i) the high-resolution features from the encoding part related to the same spatial resolution and (ii) the output of the previous decoding layer (i.e., spatially upsampled features). Over multiple iterations, the two subsequent convolutions learn to assemble a more precise output based on the concatenated input.

During training, the network learns the convolutional filters. This is done using training pairs, each consisting of an input Raw image and a corresponding reference RGB image, which is used as ground truth (GT). Initially, the convolutional filters are set to random values. A mosaicked input Raw image is input into the network, and the network regresses an output image which is a candidate RGB output representing the input image. The difference between the regressed output image and the GT image forms an error, which is back-propagated through the network from the output to the input though gradients. The weights of the network are then updated to reduce the error. The training process iterates using a large collection of image pairs until the network weights converge suitably. Once the network is trained, it can be applied to arbitrary Raw input to recover its RGB channels.

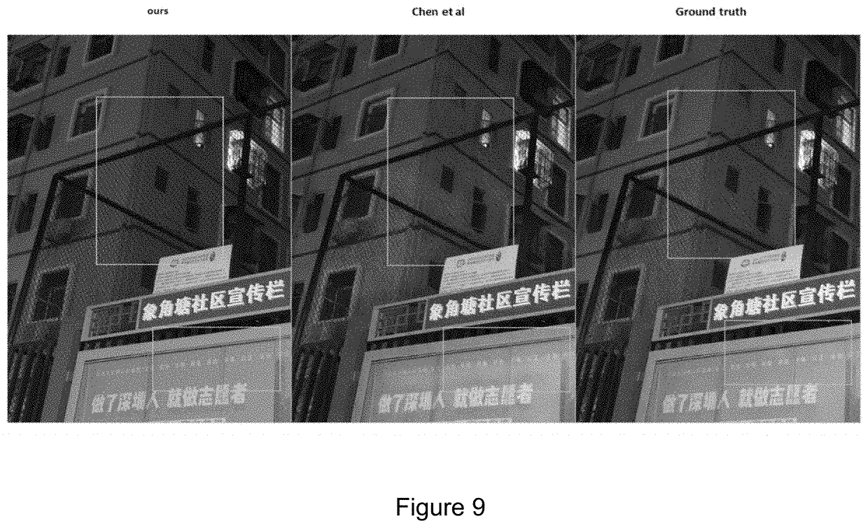

FIGS. 9 to 11 show results of example systems using the present approach.

FIG. 9 shows on the right a ground truth image corresponding to an example Raw input, on the left an RGB image formed using a network of the type shown in FIG. 8 using the present self-attention module, and for comparison in the middle an RGB image formed using the Raw to RGB method of Chen et al. (Chen, Chen and Chen, Qifeng and Xu, Jia and Koltun, Vladlen, In “Learning to see in the dark”, Proceedings of the IEEE Conference on Computer Vision and Pattern Recognition, 3291-3300, 2018). In comparison to the middle image, the left image estimates sharper edges and more realistic colors.

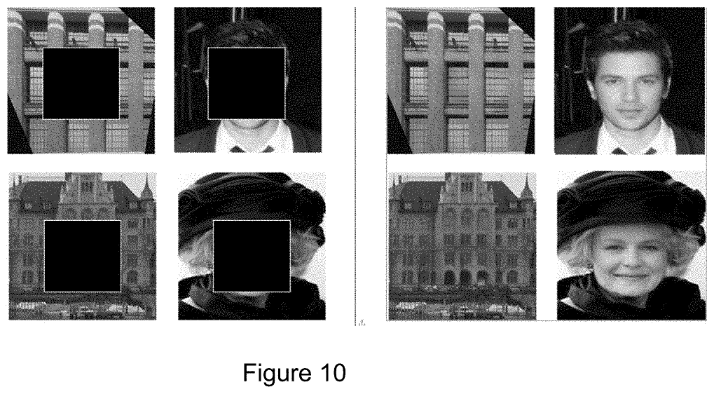

FIG. 10 shows examples of inpainting using a network of the type shown in FIG. 8 using the present self-attention module. Images on the left of FIG. 10 have a region missing. When these images input to the trained network the outputs are as shown on the right of FIG. 10.

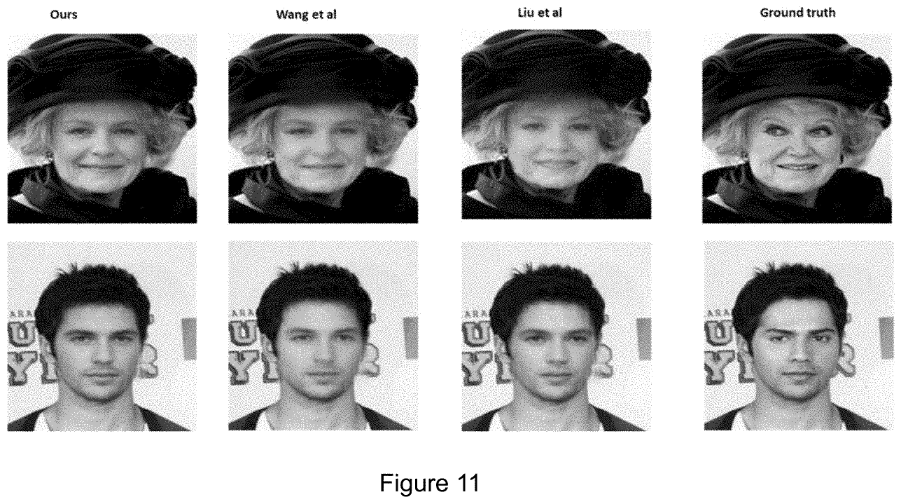

FIG. 11 shows inpainting results from the present and prior art methods. The ground truth images are on the right. The first column is formed using a network of the present type, as shown in FIG. 8 using the present self-attention module. The second column is formed by the method of Wang et al. The third column is formed by the method of Liu et al. (Liu, Guilin and Reda, Fitsum A and Shih, Kevin J and Wang, Ting-Chun and Tao, Andrew and Catanzaro, Bryan, “Image inpainting for irregular holes using partial convolutions”, Proceedings of the European Conference on Computer Vision (ECCV), 85-100, 2018).

The embodiments describe each individual feature described herein and any combination of two or more such features, to the extent that such features or combinations are capable of being carried out as a whole in the light of the common general knowledge of a person skilled in the art, irrespective of whether such features or combinations of features solve any problems described herein, and without limitation. The embodiments may have any such individual feature or combination of features. In view of the foregoing description, it will be evident to a person skilled in the art that various modifications may be made within the scope of the embodiments.

1. An image processing device for identifying one or more characteristics of an input image, the image processing device comprising a processor configured to:
receive the input image, the input image extending along a first axis and a second axis;
form a series of attribute maps based on the received input image, each attribute map representing the intensity of a respective attribute at a plurality of locations in the image;
perform a first correlation operation by identifying regions in respect of which the patterns of multiple ones of the series of attribute maps are correlated, and forming a first output in dependence on that operation;
perform a second correlation operation for identifying combinations of (i) attributes and (ii) portions of the image having common location in terms of the first axis, wherein the said combinations are correlated across multiple locations in terms of the second axis, and forming a second output in dependence on that operation; and
form a representation of the one or more characteristics of the input image in dependence on at least the first output and the second output.

2. An image processing device as claimed in claim 1, wherein the processor is further configured to:
perform a third correlation operation for identifying combinations of (i) attributes and (ii) portions of the image having common location in terms of the second axis, wherein the said combinations are correlated across multiple locations in terms of the first axis, and forming a third output in dependence on that operation;
wherein forming the representation of the one or more characteristics of the input image is further in dependence on the third output.

3. An image processing device as claimed in claim 1, wherein one of the first axis and the second axis is a horizontal image axis X, the other one of the first axis and second axis is a vertical image axis Y, the attributes form a set C and the image and the attribute maps together form a tensor having dimensions C, X and Y.

4. An image processing device as claimed in claim 3, wherein:
the output of the first correlation operation is a similarity matrix for dimensions X, Y; and
the output of the second correlation operation is a similarity matrix for dimensions C and one of X and Y.

5. An image processing device as claimed in claim 1, wherein the attributes include one or more of: the presence of a certain hue, brightness, local contrast, and a determined representation of the local likelihood of a certain feature.

6. An image processing device as claimed in claim 5, wherein the feature is a face.

7. An image processing device as claimed in claim 5, wherein the processor is further configured to perform a feature recognition operation on the input image to form a map comprising estimates of the local likelihood of a certain feature at a plurality of locations in the input image; and wherein that map constitutes one of the attribute maps.

8. An image processing device as claimed in claim 1, wherein the processor is further configured to train a convolutional neural network in dependence on the said representation.

9. A method for identifying one or more characteristics of an input image, the method comprising:
receiving the input image, the input image extending along a first axis and a second axis;
forming a series of attribute maps based on the received input image, each attribute map representing the intensity of a respective attribute at a plurality of locations in the image;
performing a first correlation operation by identifying regions in respect of which the patterns of multiple ones of the series of attribute maps are correlated, and forming a first output in dependence on that operation;
performing a second correlation operation for identifying combinations of (i) attributes and (ii) portions of the image having common location in terms of the first axis, wherein the said combinations are correlated across multiple locations in terms of the second axis;
forming a second output in dependence on that operation;
forming a representation of the one or more characteristics of the input image in dependence on at least the first output and the second output; and
training a convolutional neural network in dependence on the said representation.

10. An image processing device storing a model formed by the method of claim 9, the image processing device comprising a processor configured to receive a second input image and process the second input image by the model to form an output image.

11. An image processing device as claimed in claim 10, wherein the processor is further configured to process the second input image by the model to perform on the second input image one of a repainting operation, a raw to RGB operation, and a tile reordering operation.
